(19) United States
(12) Patent Application Publication
(10) Pub. No.: US 2004/0213007 A1
(43) Pub. Date: Oct. 28, 2004

(54) Vehicle indicator light advertising method and device

(76) Inventor: Dominic Gomez Portillo, San Pedro, CA (US)

Correspondence Address: PHILIP H. HAYMOND, 7545 IRVINE CENTER DRIVE, SUITE 200, IRVINE, CA, 92618-2933, US

(21) Appl. No.: 10/828,060

(22) Filed: Apr. 20, 2004

Related U.S. Application Data
(60) Provisional application No. 60/464,785, filed on Apr. 22, 2003.

(51) Int. Cl. F21V 21/08

(52) U.S. Cl. 362/487

(57) ABSTRACT

An applique and method for creating an applique for use on vehicle lights is disclosed. A decal is placed on the lights or tail lights of vehicles for showing a design or a trademark. A method for advertising using the applique to display trademarks for goods or services is also disclosed.

### CROSS-REFERENCE TO RELATED APPLICATIONS

This application claims benefit of the filing date of U.S. Provisional Application 60/464,785, entitled Vehicle Indicator Light Advertising Method and Device, inventor Portillo, filed Apr. 22, 2003, incorporated herein by reference.

### FIELD OF THE INVENTION

This invention relates to advertising and decoration of vehicle lights and more particularly to a method and apparatus for using appliques to modify an automotive tail light with a design or word. This invention also relates to an advertising business method to use the indicator lights of a vehicle as a medium of advertising by altering them sufficient to create an advertisement, particularly by modifying a automotive tail light with a logo or word trademark to use in advertising.

### BACKGROUND OF THE INVENTION

An undeveloped avenue of advertising and/or vehicle identification is the use of brake and turn signal lights of motor vehicles. An exemplary tail light is comprised of a housing, containing a light source, such as a bulb, and a reflector. The housing is covered with a lens, typically red or amber in color.

Several industries could make use of such a device for advertising or marking their products or services. Truck and trailer rental services, for example, could mark their vehicles in this manner to identify and advertise their vehicles as they are being used by customers. Trailer rental services also frequently provide brake light connectors that are connected to the electrical lighting circuit of the towing vehicle to cause the trailer's tail lights to activate simultaneously with the towing vehicle's lights. It is self-apparent that such a method of advertising would create a great number of customer advertising contact opportunities by being seen on roads throughout a service area, perhaps nationally on the roads of America by other potential customers.

This method of advertising would allow an economical yet highly visible means for marketing a company's trademark logo or name. It could also be used to mark other vehicles, such a emergency vehicles or those belonging to motorist clubs, to allow them to be more readily identified by other motorists.

### SUMMARY OF THE INVENTION

A applique is created from a decal made from a sheet of durable flexible material such as vinyl, which cut to delineate a desired name, picture or logo. One or more sheets may be layered to create the finished design. The lens of a light fixture, in this example a tail light, having a lens, housing and a light source, is removed from the housing and the one or more sheets are applied to the lens. The lens is then reattached to the light housing and, when lit by a light source within the housing of the light, illuminates the design in silhouette to display to other motorists. In one embodiment the decal is die-cut. The pattern may also be created by scanning existing art work into a computer graphics file, or by originally creating the design on a computer file, and cutting the decal according to the design. The decal then can be cut by hand or by having the computer guide the cutting instrument.

The visual effect of the applique can be enhanced by further affixing a second sheet to the lens, adapted to diffuse light from the light source passing around the decal.

The decal portion of the applique is preferably made of vinyl. Adhesive can be applied to either the decal or the second sheet to affix to the lens. Either the decal or the second sheet may further be shrunk with heat to fit snugly over the lens.

A method for applying the applique to a vehicle light is also disclosed. A decal sized to fit on the lens is provided made according to one or more of the above descriptions and affixed to the lens. The second, light-diffusing sheet may also be affixed to the lens in this manner. The lens is then affixed to the light fixture so that the light from the light source passes around the decal and, if it is used, through the second sheet.

A method for advertising is also disclosed. In the preferred embodiment a decal is made according to one or more of the above description to act as an identifying a trademark. The trademark when used on a vehicle is observed by other motorists, increasing the recognition of the trademark. This method is especially useful in identifying a fleet of vehicles commonly owned by one user, such as a fleet of rental cars, moving trucks or trailers.

### BRIEF DESCRIPTION OF THE DRAWINGS

FIG. 1 is an exploded cutaway view of an example a tail light.

FIG. 2 is a front view of die-cut vinyl decal.

FIG. 3 is a front view of a second vinyl sheet used to diffuse light.

FIGS. 4A-4F are a series of front views illustrating the steps the method of the present invention.

FIG. 5 is a flow chart of the method of the present invention.

### DETAILED DESCRIPTION OF THE INVENTION

The following detailed description, and the figures to which it refers, are provided for the purpose of describing examples and specific embodiments of the invention only and are not intended to exhaustively describe all possible examples and embodiments of the invention. Further objects and advantages of the invention will become apparent to one skilled in the art by reading and understanding the following description and the drawings to which it refers, wherein the advantages of the present invention are set forth in the claims when considered in conjunction with the accompanying drawings in which like parts bear like reference numerals.

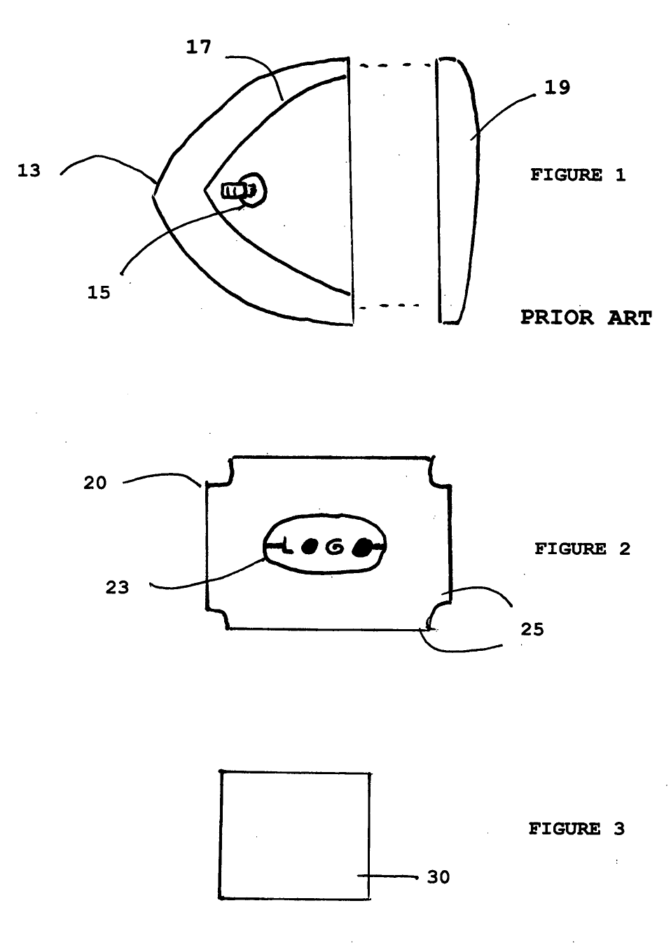

The method of the presently preferred embodiment is illustrated using as an example a prior art tail light 11 of FIG. 1. This exemplary tail light comprises a housing 13, a light source 15 such as a bulb, a reflector 17 and by way of example a three-inch square lens 19.

A flexible sheet material, such as Neschen vinyl (Hans Neschen GmbH & Co KG, Buckeburg, Germany) is provided on which to cut or die-cut a preferred design. In this method the ultimate design will be monochromatic, it will be the color of the light lens. It is best to first make a black and white print of the design, or create it as a computer file using graphics software such as Adobe Illustrator (Adobe Systems Incorporated, San Jose, Calif.). Generic shapes and figures may be obtained for use in the design from commercial software vendors, such as the SignPost multimedia library and plotter control software (Signpost software (Signpost company, London, UK).

The design may also be created by scanning existing artwork into a computer graphics file or by originally creating the design on a computer, storing it in a file. Simple and bold designs are preferred for this die-cutting process. The vinyl is die cut until the finished art work is composed of one or more sheets of this flexible material.

By way of example, in the case of a three-inch square brake light, Neschen vinyl of one color, e.g. their Neschen Pro-Cal 5™, black in color, having one adhesive side, is die-cut using SignPost 4.0 software and a die-cutting plotter, such as an Ioline plotter (Ioline Corporation, Woodinville, Wash.). A decal 20, shown in FIG. 2, may comprise a logo 23 for example, centered on a sheet having four 4.08″×4.08″ tabular sections 25 to adhere to the sides of the exterior of the lens. The die-cut vinyl decal is then covered with application tape for transferring vinyl graphics to a lettering substrate, using an application tape such as TransferRite® tape (American Biltrite Inc., Cambridge, Mass.).

In this example the decals are applied to the lens 19 after it has been removed from the tail light. The logo 23 of the vinyl decal is centered on and applied to the exterior surface of the lens. Adhering the decal to the lens is preferably finished by applying the adhesive side of the decal to a dampened lens, then using a squeegee to remove any trapped air bubbles. In the preferred embodiment a hot air gun is then used to blow heat on the vinyl to melt or shrink-wrap the edges of the decal to the lens to produce the best result.

In the preferred embodiment a second vinyl sheet 30 of FIG. 3, is also provided to diffuse the light passing through the decal. Many lenses use an undesirably textured interior surface to focus the light and this second sheet counteracts this effect by diffusing the light instead, to improve the look of the design. The diffusing sheet 30 is fitted for the interior side of the lens as a 3″×3″ square sheet. In the present example the second sheet is made from a red Neschen Pro-Cal 5™. The second sheet is adhered to the interior side of the lens, opposite the decal 20, which together produce a desired design. The lens is reattached to the tail light and otherwise used in the ordinary manner, providing a view to other motorists.

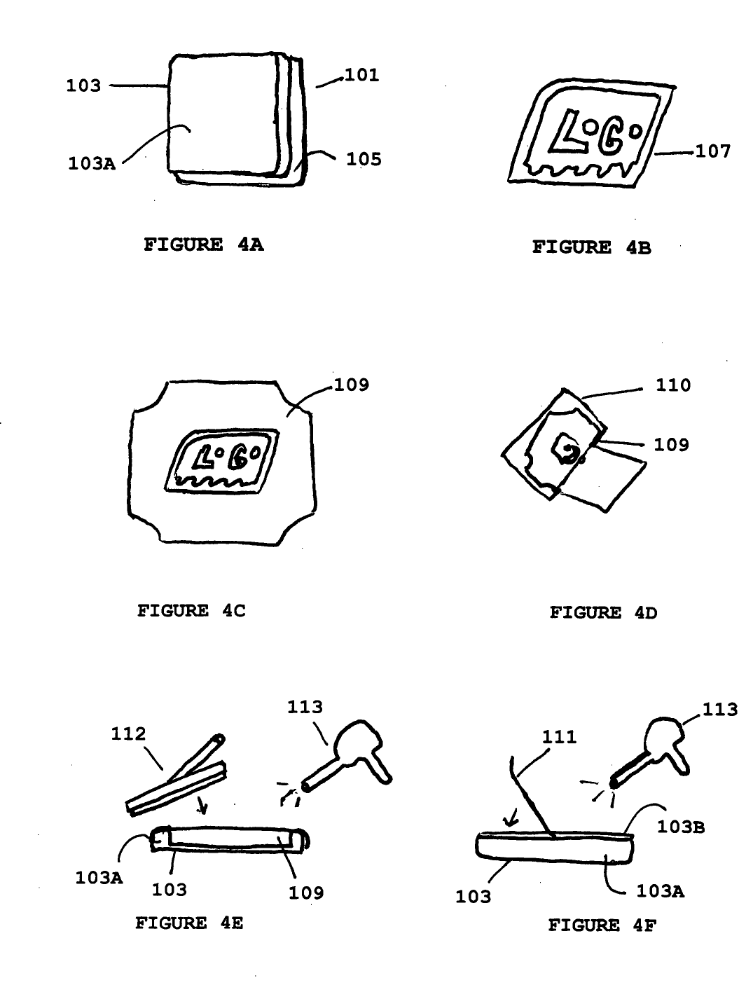

FIGS. 4A-4F illustrate the steps of creating an exemplary completed tail light. A standard brake light 101 is shown having a lens 103, showing the exterior side 103A, a light bulb (not shown) as an internal light source and a housing 105. Exemplary desired logo 107 of FIG. 4B is selected to be made into a decal. The logo 107 may be scanned into a computer and used as a template to cut the components of vinyl decal 109 of FIG. 4C by methods known to those of skill in the art.

The decal 109 is then transferred as in FIG. 4D to the lens 103 using application tape 110. It is centered on and applied to the exterior side of the lens 103A as shown in FIG. 4E, with either an adhesive or by using vinyl made with an adhesive side. The lens is dampened and the decal is pressed onto the lens 103 by applying the adhesive side of the decal to a dampened lens, then using a squeegee 112 to remove any trapped air bubbles. In the preferred embodiment a hot air gun 113 is then used to blow heat on the vinyl to melt or shrink-wrap the edges of the decal to the lens. A diffusing sheet 111 may likewise be applied (shown by arrow) to the interior side 103B of the lens 103, as shown in 4F, with the squeegee 112 and hot air gun 113. The lens 103 is then affixed to the light housing 105 and the logo is illuminated when the light source is activated.

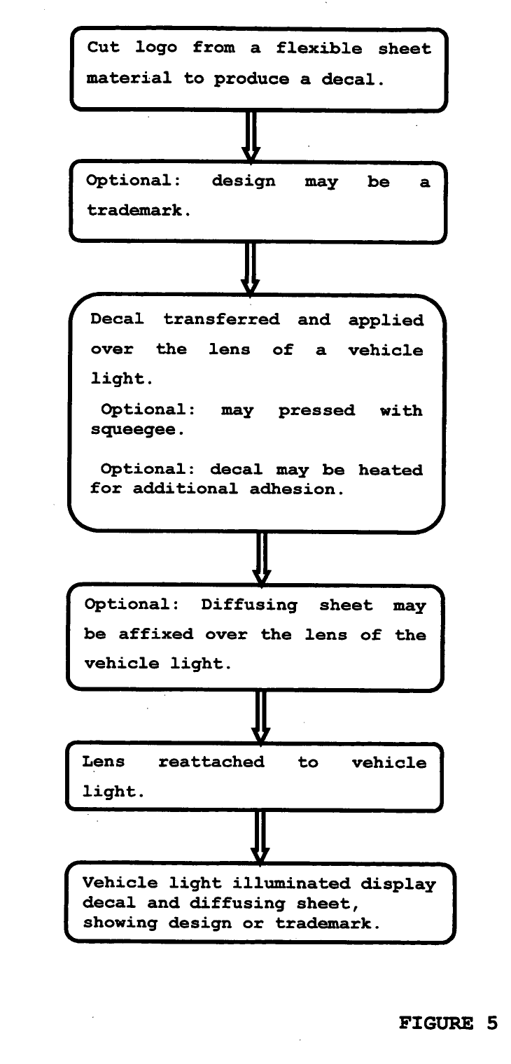

A method of the present invention is straightforward as shown in FIG. 5. A desired logo is cut from a flexible sheet material to produce a decal. The decal is then transferred to the exterior of a tail light, and may pressed with a squeegee or melted with a hot air gun to facilitate adhesion. A diffusing sheet may also be used, applied to the interior side of the tail light lens. The modified lens is then affixed to the light housing and the logo is illuminated when the light source is activated.

The above applique or similar coverings are used to apply a design, logo or name to a light, preferably one or more tail lights of one or more vehicles. According to another method the tail lights are used on vehicles owned or authorized by the user, providing widespread advertising and identification for the subject trademark design, initials or words.

The present invention has been described above in terms of a presently preferred embodiment so that an understanding of the present invention can be conveyed. There are, however, many configurations for advertising method and device not specifically described herein but with which the present invention is applicable. The present invention should therefore not be seen as limited to the particular embodiments described herein, but rather, it should be understood that the present invention has wide applicability with respect to event-tracking generally. All modifications, variations, or equivalent arrangements and implementations that are within the scope of any patent claims issuing hereon and should therefore be considered within the scope of the invention.

What is claimed is:

1. An applique for a vehicle light fixture having a light source, a housing and a lens, comprising:
a decal made of one or more sheets of durable flexible material cut to delineate a desired design and sized to fit on a lens of a vehicle light fixture, and
the decal is affixed to the lens so that an image of the design is illuminated by light from the light source in the vehicle light fixture.

2. The applique of claim 1, wherein at least one sheet of the flexible material is die-cut.

3. The applique of claim 1 where the design is created by scanning existing art work into a computer graphics file and cutting the decal according to the design of the scanned art work.

4. The applique of claim 1 where the design is created by originally creating the design on a computer and then cutting the decal according to that design.

5. The applique of claim 1 further comprising a diffusing sheet affixed to the lens wherein the diffusing sheet diffuses light from the light source.

6. The applique of claim 1 wherein at least one of the one or more sheets of durable flexible material is made of vinyl.

7. The applique of claim 1 wherein at least one sheet of the one or more sheets of flexible material includes an adhesive backing.

8. The applique of claim 1 wherein the diffusing sheet or at least one sheet of the one or more sheets of flexible material is further caused to adhere to the lens by applying heat to the sheet.

9. A method for applying an applique to a vehicle light fixture having a light source, a housing and a lens, comprising the steps of:
providing a decal sized to fit on a lens for a vehicle light fixture by cutting one or more sheets of durable flexible material to delineate a design,
affixing the decal to the lens so that so that light from a light source in a light fixture fitted with the lens illuminates the decal.

10. The method of claim 9, wherein at least one sheet of the durable flexible material is die-cut.

11. The method of claim 9, further comprising the step of creating the design by scanning existing art work into a computer graphics file and cutting the decal according to the design of the scanned art work by using the scan of the art work as a template.

12. The method of claim 9, further comprising the step of creating the design by originally creating the design on a computer file and cutting the decal according to that design the art work as a template.

13. The method of claim 9, further comprising the step of affixing to the lens one or more diffusing sheets adapted to diffuse light from the light source illuminating the decal.

14. The method of claim 9 further including the step of affixing at least one of the one or more decals sheets and diffusing sheets, by applying hot air to the sheet.

15. The method of claim 9 wherein at least one of the decal sheets and the second sheets further includes an adhesive backing.

16. A method for advertising, comprising the steps of:
providing a decal sized to fit on a lens for a first vehicle light fixture by cutting one or more sheets of durable flexible material to delineate a trademark design,
affixing the decal to the lens so that so that light from a light source in a light fixture fitted with the lens illuminates the decal,
using the vehicle in traffic, thereby causing the trademark to be viewed by other vehicle operators when they see the first vehicle.

17. The method of claim 16 further comprising the step of affixing to the lens one or more diffusing sheets adapted to diffuse light from the light source illuminating the decal.

18. The method of claim 16 where the decal is placed on a tail light of the first vehicle.

19. The method of claim 18 further comprising the step of affixing to the lens one or more diffusing sheets adapted to diffuse light from the light source passing through the decal.

20. The method of claim 16, further comprising the step of a user placing the decal on the lights of a plurality of vehicles commonly operated by an entity and the trademark used is that of the entity.
